(19) United States
(12) Patent Application Publication
(10) Pub. No.: US 2026/0338246 A1
(43) Pub. Date: Oct. 29, 2026

(54) INERTIA DAMPENING SYSTEM FOR COUNTERWEIGHT IN MOTION

(71) Applicant: Motor City Wash Works, Inc., Wixom, MI (US)

(72) Inventors: Lionel Belanger, Northville, MI (US); Doug Calvin, Livonia, MI (US); Michel LeCourt, Westland, MI (US)

(73) Assignee: Motor City Wash Works, Inc., Wixom, MI (US)

(21) Appl. No.: 19/658,780

(22) Filed: Apr. 27, 2026

Related U.S. Application Data
(60) Provisional application No. 63/794,991, filed on Apr. 25, 2025.

(51) Int. Cl. F16F 7/12; B60S 3/06; F16P 3/02

(52) U.S. Cl. CPC F16F 7/12; F16P 3/02; B60S 3/066

(57) ABSTRACT

An inertial dampener associated with a moving counterweight reduces the potential of injury to a person by deforming and moving the person out of the motion path of the counterweight without stopping the motion of the counterweight. The inertial dampener includes a sheath that circumferentially surrounds the counterweight and is attached to a pivotable arm holding the counterweight.

### CROSS-REFERENCE TO RELATED APPLICATIONS

This application is a Non-Provisional patent application, which claims the benefit of U.S. Provisional Patent Application 63/794,991, filed Apr. 25, 2025, the entire contents of which are incorporated herein by reference.

### TECHNICAL FIELD

The disclosure generally relates to dampening systems for equipment to prevent injury and more particularly to an inertial dampening system configurable to prevent injury from a counterweight associated with a moving arm, such as an automated moving arm actuating a vehicle cleaning roller in a carwash.

### BACKGROUND

Various cushioning and dampening systems exist in industrial equipment environments to prevent or reduce injury to anyone working in and around the equipment. A common solution is to provide padding on equipment, such as a counterweight for an automated moving arm, which is attached at one end to a carwash roller and at the other to a counterweight. In theory, the padding will absorb the energy of a blow from the equipment striking a person. However, if the mass of the moving equipment is significant, padding, unless extremely thick and bulky, may not prevent a person from sustaining serious injury.

Other solutions exist, such as cameras or other sensors, to sense the presence of a person in proximity to a moving counterweight and deactivate the system's movement. These systems add to the overall cost and maintenance of a system. Some equipment may not adapt well to sudden stoppage. In a carwash setting, a damp environment reduces the lifespan and functionality of certain electronics, such as sensors that could detect a person's presence near moving equipment, such as car wash rollers' counterweights.

Therefore, there are opportunities to improve the prevention of injuries from moving equipment, such as those caused by counterweights on an automated car wash roller arm.

### SUMMARY

It is an advantage of the present disclosure to provide an inertia-damping system including a sheath that circumnavigates a surface of equipment, such as a counterweight on a moving arm, the moving arm having a counterweight at one end and a car wash roller at the other end. The sheath is attached at one or more locations to the arm in proximity to the counterweight. The attachment point is located to allow a full circumferential gap between the sheath and the counterweight. The sheath is displaced from an outward surface of the counterweight to provide an inertial displacement gap between the counterweight and the sheath. The gap is adjusted to provide maximum warning to anyone who could come into contact with the counterweight. Other advantages will become clear from the detailed description of the invention, including the drawings.

In another aspect of the disclosure, an inertial dampener is associated with a counterweight and adapted for reducing potential injury to a person in the path of the counterweight when in motion. The inertial dampener includes a sheath adapted to at least partially circumferentially surround a counterweight and be spaced from a surface of the counterweight, where the sheath has a width substantially matching or larger than the width of the counterweight, where the sheath comprises a rigid material, where the rigid material is deformable by a force significantly less than a stopping force needed to stop the movement of the counterweight, where the sheath is adapted to deform when contacting a person in the path of the counterweight and the counterweight is not prevented from moving.

The disclosure further includes the inertial dampener where the sheath is associated with the counterweight at a minimal number of locations.

The disclosure further includes the inertial dampener where the minimal number of locations is no more than two.

The disclosure further includes the inertial dampener, further comprising at least one flange connected to the sheath, wherein the at least one flange connects the sheath to at least one of the counterweight and an articulating arm, wherein the sheath forms a circumferentially displaced barrier from the counterweight.

The disclosure also includes the inertial dampener, in which the sheath is deformable by a force less than one hundredth of the force required to deform the counterweight.

The disclosure includes an inertial dampener in which the sheath is configured to deform over a distance greater than the deformation distance of the counterweight upon impact with a person.

The disclosure also includes the inertial dampener, in which the sheath has a mass less than 10% of the counterweight's mass.

The disclosure includes an inertial dampener in which the sheath is spaced from the counterweight by a gap sufficient to allow the sheath to deform prior to contact between the counterweight and an object.

The disclosure includes the inertial dampener where the sheath is configured such that an initial impact force exerted by the sheath is at least an order of magnitude less than an impact force that would be exerted by the counterweight under the same motion conditions.

The disclosure includes a method of reducing injury to a person from a moving counterweight associated with an automated apparatus, where the method includes providing a counterweight coupled to an arm configured to move about an axis; positioning a sheath at least partially circumferentially around the counterweight, the sheath being spaced from the counterweight by a gap; configuring the sheath to have a mass substantially less than a mass of the counterweight and to be deformable upon impact; moving the arm such that the counterweight travels along a path of motion; and contacting a person with the sheath prior to contact between the counterweight and the person, wherein the sheath deforms upon contact with the person and reduces an impact force transmitted to the person relative to direct contact with the counterweight.

The disclosure includes a method in which the mass of the sheath is less than 10% of the mass of the counterweight.

The disclosure includes a method in which the sheath is configured so that an initial impact force exerted by the sheath is at least one order of magnitude less than the impact force that would be exerted by the counterweight under substantially identical motion conditions.

The disclosure includes the method, further comprising deforming the sheath over a deformation distance greater than the deformation distance of the counterweight upon impact.

The disclosure also includes the method where the sheath absorbs kinetic energy of the moving counterweight by deforming prior to the transfer of force from the counterweight to the person.

The disclosure includes a method in which the gap between the sheath and the counterweight is sufficient to permit deformation of the sheath before the counterweight contacts the person.

The disclosure includes the method, further comprising maintaining the sheath in spaced relation to the counterweight by at least one attachment point located on the arm.

The disclosure includes a method in which contacting the person with the sheath provides a warning sufficient to allow the person to move out of the path of the counterweight before contact occurs.

The disclosure includes a method in which the arm is continuously moved during contact with the sheath, so that the counterweight is not stopped before the sheath contacts the person.

The disclosure includes the method where the sheath comprises a metal sheet having a thickness of approximately ⅛ inch.

The disclosure includes the method where the sheath comprises a deformable material selected from aluminum, steel, or a polymeric material.

The disclosure includes a method in which the automated apparatus comprises a carwash system including a rotating cleaning element disposed opposite the counterweight.

The disclosure includes a method in which the arm rotates arcuately upwardly and downwardly about the axis while carrying the counterweight.

In accordance with the above and other advantages of the present disclosure, an inertial dampener associated with a counterweight and adapted for preventing and reducing injury to a person with the counterweight in motion, the inertial dampener including a sheath adapted to at least partially circumferentially surround a counterweight and be spaced from a surface of the counterweight, where the sheath has a width substantially matching or larger than the width of the counterweight. The sheath further comprises a rigid material that is deformable by a force significantly less than the stopping force required to stop the movement of the counterweight. The sheath is adapted to deform when it contacts a person in the path of the counterweight's movement, and the counterweight is not prevented from moving.

### BRIEF DESCRIPTION OF THE DRAWINGS

Advantages of the present disclosure will be readily appreciated as the same becomes better understood by reference to the following detailed description when considered in connection with the accompanying drawings wherein:

FIGS. 1A and 1B are front and side views of an inertial dampener of a non-limiting embodiment of the disclosure; and

FIGS. 2A-2C are side and perspective schematic type views of the inertial dampener with a counterweight as adapted for use with a carwash washing system.

### DETAILED DESCRIPTION

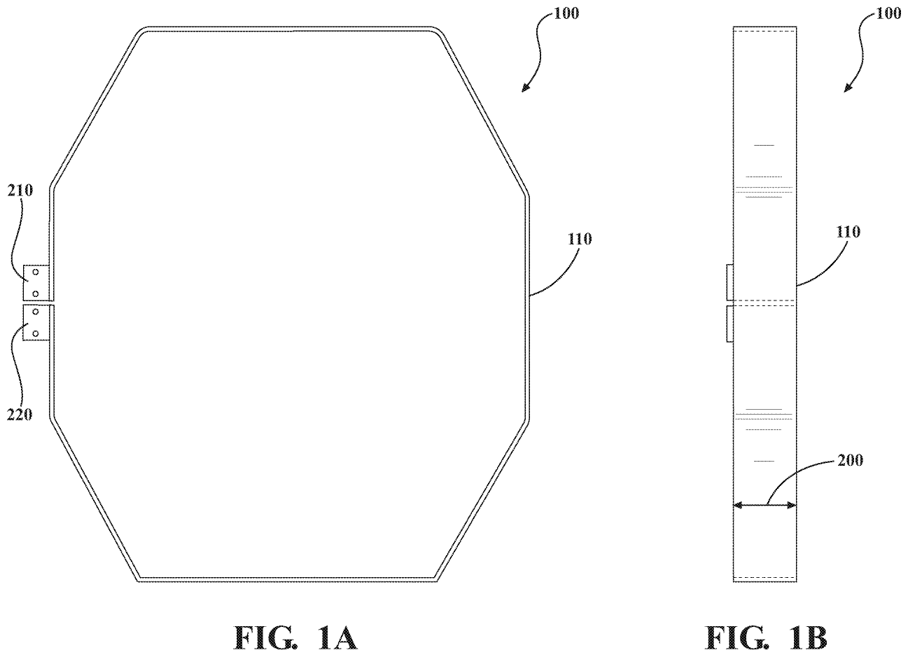

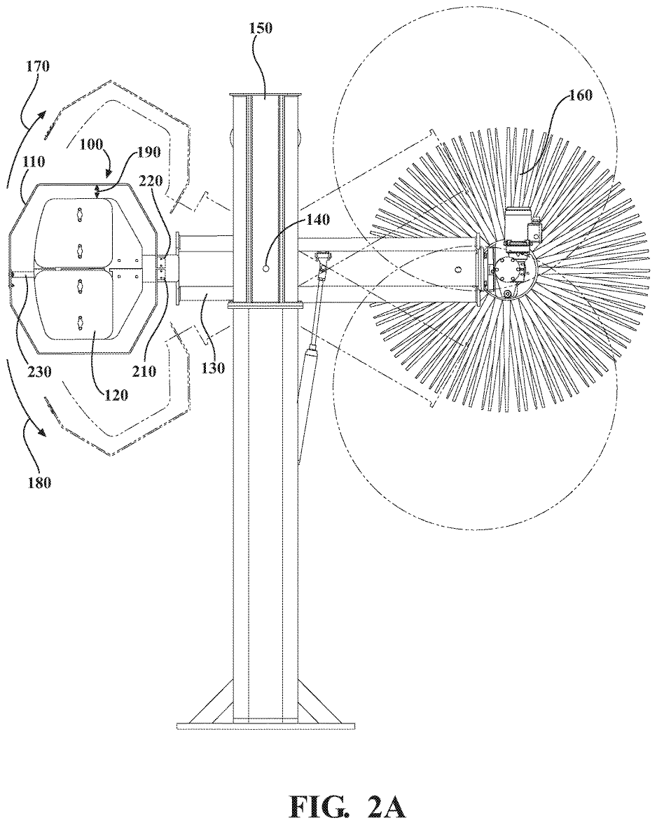

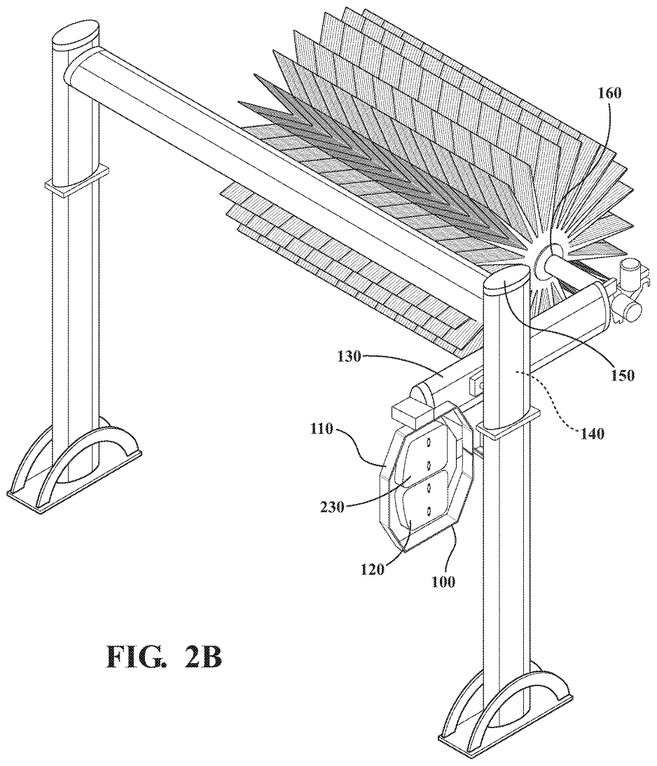

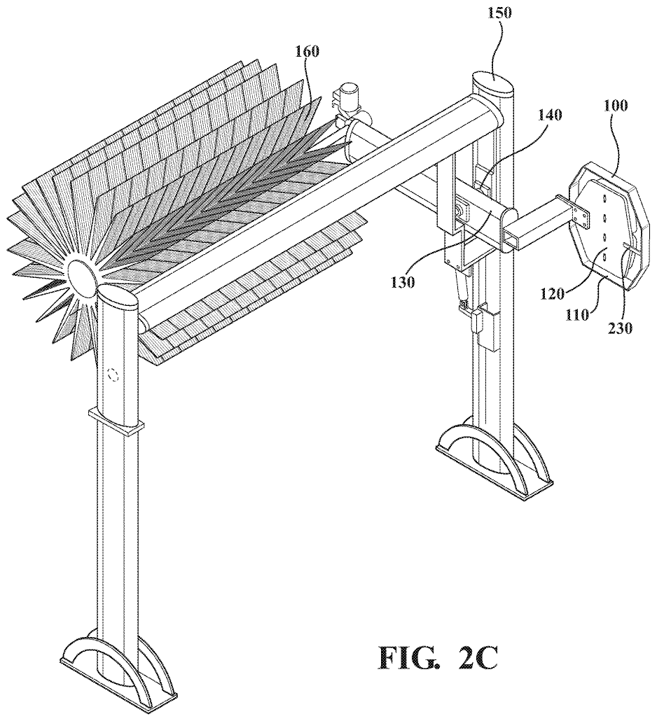

Referring to FIGS. 1A-2C, an inertial dampener 100, includes a sheath 110 adapted to circumferentially surround a counterweight 120 of significant mass. The counterweight 120 is connected to an arm 130 that pivots about an axle 140. The counterweight 120 is supported by an automated apparatus 150. As seen in the non-limiting embodiments of the disclosure, the automated apparatus 150 includes a rotatable washing system 160, commonly found in carwashes. Movement of the counterweight 120, arm 130, and washing system 160 is controlled by a control system (unseen) of the type well known to a person of ordinary skill in the art. The counterweight 120 rotates arcuately upwardly 170 and arcuately downwardly 180 about the axle 140. It should be appreciated that the automated apparatus 150 could take many forms commonly found in automated industrial applications, including non-carwash-related applications. The upwardly 170 and downwardly 180 motion of the counterweight 120 puts it on a course that could strike a person standing in proximity to the arm 130 and counterweight 120. To reduce potential injury to a person, the inertial dampener 100 provides a barrier between a person who could be struck by the counterweight 120.

The sheath 110 of the inertial dampener 100 is separated from the counterweight 120 by a distance 190 adequate to allow the inertial dampener 100 to deform and exert a far less striking force on the person than the force of the counterweight 120. The sheath 110 of the inertial dampener 100, in a non-limiting embodiment, is an aluminum sheet of width 200 adequate to cover the corresponding width of the counterweight 120. The aluminum sheet in a non-limiting embodiment is ⅛th inch thick. It should be appreciated that other suitable materials are available, including but not limited to stainless steel, plastic sheets, and carbon fiber. The sheath 110 is associated with the arm 130 by attachment with bolts or screws at a first and second flange portion 210, 220. In a non-limiting embodiment, the sheath 110 may also be held in place by a stabilizer bar 230 connected between the counterweight 120 and the sheath 110 at a side distal to the first and second flange 210, 220.

The inertial dampener 100 provides a significant difference in mass between the sheath 110 and the counterweight 120 which allows the inertial dampener 100 to deform when it strikes an object such as a person before the person is struck by the counterweight 120. It is known that momentum is defined as p=mν, where p is momentum, m is mass, and ν is velocity. Impact forces experienced during a collision are more accurately characterized using energy and deceleration relationships, including kinetic energy E==½mν² and force approximations based on stopping distance or time. It is also known that inertia is a natural tendency of objects to resist a change in their state of motion. Inertia increases as the mass of an object increases. Inertia is directly proportional to the mass; that is, inertia increases with the increase in the mass and decreases with the decrease in the mass. As an example, the mass of the counterweight 120 could be one hundred (100) times (or more) the mass of the inertial dampener 100. As the arm 130 rotates downwardly 180 at a velocity, the inertial dampener 100 would first strike a person in the way of the motion. Since the mass of the inertial dampener 100 is far less than the counterweight 120, the inertial dampener 100 will deform before the mass of the counterweight 120 strikes the person. For a further example, if the counterweight 120 were to strike the head of a person, it could easily cause very serious injuries. If the inertial dampener 100 struck the person's head, it would dramatically reduce the risk of injury because the force would be much lower. An important benefit of the inertial dampener 100 is the ability to alert a person to the presence of the moving arm 130 and counterweight 120. It is expected that once a person is struck by the inertial dampener 100, they will be pushed out of the way or will quickly move out of the way of the counterweight 120.

In some embodiments, the inertial dampener 100 is configured such that a person in the path of motion of the counterweight 120 is first contacted by the sheath 110 rather than by the counterweight 120 itself. The inventors have recognized that the potential for injury to a human head is strongly influenced by the effective moving mass at impact, the impact velocity, and the stopping distance over which the impact occurs.

Published biomechanical studies indicate that skull fracture risk increases substantially when impact forces reach several kilonewtons, with reported fracture thresholds commonly in the range of approximately 3.5 kN to 7 kN, depending on impact conditions and anatomical variation. Accordingly, reducing the effective force transmitted during impact can significantly reduce the likelihood of serious injury.

To illustrate the advantages of the inertial dampener 100, consider a non-limiting example in which the counterweight 120 has a mass of approximately 100 kg and is moving at a velocity of approximately 1.0 m/s.

In this example, the kinetic energy of the counterweight 120 is:

$${E}_{c} = \frac{1}{2} ( 100 ) {( 1. )}^{2} = 50 joules$$

If the counterweight 120 were to directly strike a person's head and come to rest over a short stopping distance of approximately 10 mm (0.01 m), the average force may be approximated as:

$${F}_{avg , c} \approx \frac{50}{0.01} = 5000 N$$

Such force levels fall within ranges associated with a significant risk of skull fracture and serious injury.

By contrast, in an embodiment of the inertial dampener 100, the sheath 110 may have a substantially lower mass, for example approximately 4 kg to 6 kg, or even much less and may be configured to deform over a significantly larger stopping distance, for example approximately 25 mm to 50 mm, before substantial force transfer from the counterweight 120 occurs.

For a sheath mass of 4 kg at the same velocity:

$${E}_{s} = \frac{1}{2} ( 4 ) {( 1. )}^{2} = 2 joules$$

Assuming deformation over a stopping distance of 50 mm (0.05 m):

$${F}_{avg , s} \approx \frac{2}{0.05} = 40 N$$

Even under less favorable conditions, such as a 6 kg sheath and 25 mm stopping distance:

F_{avg,s}≈120 N

Accordingly, the inertial dampener 100 can reduce the initial impact force by approximately one to two orders of magnitude relative to direct impact by the counterweight 120. This reduction is further reinforced by the difference in momentum. At 1.0 m/s, a 100 kg counterweight has a momentum of 100 Nos, whereas a 4 kg sheath has a momentum of only 4 N·s. Thus, the initial contact delivers only a small fraction of the total system momentum.

Importantly, the sheath 110 is deformable and spaced from the counterweight 120 by distance 190, as shown in FIGS. 1A-2C. This configuration allows the sheath 110 to absorb energy and extend the duration of the impact, thereby reducing peak force and providing a warning contact that enables a person to move out of the path of the counterweight 120.

These examples are illustrative and non-limiting. Actual forces will depend on the mass of the counterweight 120, the mass and material properties of the sheath 110, the gap distance 190, the velocity of the arm 130, and the characteristics of the object contacted. However, the governing principle remains that interposing a lighter, deformable structure significantly reduces the force transmitted during initial contact and thereby reduces the likelihood of serious injury.

It is a method of the disclosure to provide an inertial dampener 100 circumferentially around and in loose association with a counterweight 120; rotating the counterweight 120 about an axis, so that when the inertial dampener 100 comes into contact with an object such as a person, deforming the inertial dampener 100 where less force is exerted on the object without stopping or slowing the motion of the counterweight 120.

The inertial dampener 100 is designed to enhance the stability and efficiency of a carwash washing system. The system comprises several interconnected components, each serving a specific function within the overall mechanism.

The sheath 110 surrounds the counterweight 120, providing protection to anyone in its proximity. The sheath 110 can absorb force should the counterweight 120 strike a sensitive object, such as a human, by deforming its shape and transferring significantly less force to the sensitive object than a solid, non-deforming object, such as the counterweight 120.

The first flange 210 and the second flange 220 are positioned strategically to provide additional support and stabilization to the arm 130 and axle 140. These flanges work in conjunction with the stabilizer bar 230, which further enhances the structural integrity and operational stability of the inertial dampener 100.

Overall, the described system is engineered to provide a reliable, efficient, and cost-effective safety solution for carwash operations and enhance the performance of the overall washing system.

The method of operation may begin with an initial positioning of the components. The inertial dampener 100 is integrated into the automated apparatus 150. The sheath 110 surrounds the counterweight 120, which is connected to the arm 130. The arm 130 is mounted on the axle 140, allowing rotational movement.

Upon activation, the automated apparatus 150 initiates movement of the rotatable washing system 160. This movement generates forces that are transferred through the arm 130 to the counterweight 120 and the inertial dampener 100.

The counterweight 120 may begin an arcuate motion upwardly 170 due to the rotational force applied by the axle 140. The stabilizer bar 230 helps maintain the alignment of the sheath 110 surrounding the counterweight 120. It is positioned to be away from likely impact points on the inertial dampener 100 by a person.

At some point, the counterweight 120 will descend in an arcuate motion downward 180. During this motion, the inertial dampener 100 absorbs kinetic energy, thus reducing the potential of injury to anyone struck by the counterweight 120. It is also possible that a person could be in the way of the counterweight 120 as it is in an arcuate motion upwardly 170. Again, the inertial dampener 100 will absorb kinetic energy, reducing the risk of injury if struck by the counterweight during upward motion.

The stabilizer bar 230, in conjunction with the first flange 210 and second flange 220, ensures that the inertial dampener 100 maintains a consistent distance 190 from the counterweight.

The inertial dampener 100 completes its cycle as the counterweight 120 returns to its initial position, ready to repeat the process with each rotation of the rotatable washing system 160.

Several embodiments have been discussed in the foregoing description. However, the embodiments discussed herein are not intended to be exhaustive or limit the invention to any particular form. The terminology which has been used is intended to be in the nature of words of description rather than of limitation. All the disclosed embodiments are intended to be non-limiting embodiments. Many modifications and variations are possible in light of the above teachings, and the invention may be practiced otherwise than as specifically described.

What is claimed is:

1. An inertial dampener associated with a counterweight and adapted for reducing potential injury to a person in a path of the counterweight when in motion, the inertial dampener comprising:
a sheath adapted to at least partially circumferentially surround a counterweight and be spaced from a surface of the counterweight, wherein the sheath has a width substantially matching or larger than the width of the counterweight, wherein the sheath comprises a rigid material, wherein the rigid material is deformable by a force significantly less than a stopping force needed to stop the movement of the counterweight, wherein the sheath is adapted to deform when contacting a person in the path of the counterweight and the counterweight is not prevented from moving.

2. The inertial dampener of claim 1, wherein the sheath is associated with the counterweight at a minimal number of locations.

3. The inertial dampener of claim 2, wherein the minimal number of locations is no more than two.

4. The inertial dampener of claim 1 further comprising at least one flange connected to the sheath, wherein the at least one flange connects the sheath to at least one of the counterweight and an articulating arm, wherein the sheath forms a circumferentially displaced barrier from the counterweight.

5. The inertial dampener of claim 1, wherein the sheath is deformable by a force less than one hundredth of the force needed to deform the counterweight.

6. The inertial dampener of claim 1, wherein the sheath is configured to deform over a distance greater than a deformation distance of the counterweight upon impact with a person.

7. The inertial dampener of claim 1, wherein the sheath has a mass less than 10% of a mass of the counterweight.

8. The inertial dampener of claim 1, wherein the sheath is spaced from the counterweight by a gap sufficient to allow deformation of the sheath prior to contact between the counterweight and an object.

9. The inertial dampener of claim 1, wherein the sheath is configured such that an initial impact force exerted by the sheath is at least an order of magnitude less than an impact force that would be exerted by the counterweight under the same motion conditions.

10. A method of reducing injury to a person from a moving counterweight associated with an automated apparatus, the method comprising:
providing a counterweight coupled to an arm configured to move about an axis;
positioning a sheath at least partially circumferentially around the counterweight, the sheath being spaced from the counterweight by a gap;
configuring the sheath to have a mass substantially less than a mass of the counterweight and to be deformable upon impact;
moving the arm such that the counterweight travels along a path of motion; and
contacting a person with the sheath prior to contact between the counterweight and the person, wherein the sheath deforms upon contact with the person and reduces an impact force transmitted to the person relative to direct contact with the counterweight.

11. The method of claim 10, wherein the mass of the sheath is less than 10% of the mass of the counterweight.

12. The method of claim 10, wherein the sheath is configured such that an initial impact force exerted by the sheath is at least one order of magnitude less than an impact force that would be exerted by the counterweight under substantially identical motion conditions.

13. The method of claim 10, further comprising deforming the sheath over a deformation distance greater than a deformation distance of the counterweight upon impact.

14. The method of claim 10, wherein the sheath absorbs kinetic energy of the moving counterweight by deforming prior to transfer of force from the counterweight to the person.

15. The method of claim 10, wherein the gap between the sheath and the counterweight is sufficient to permit deformation of the sheath before the counterweight contacts the person.

16. The method of claim 10, further comprising maintaining the sheath in spaced relation to the counterweight by at least one attachment point located on the arm.

17. The method of claim 10, wherein contacting the person with the sheath provides a warning sufficient to allow the person to move out of the path of the counterweight before contact with the counterweight occurs.

18. The method of claim 10, wherein the arm is moved continuously during contact with the sheath such that the counterweight is not stopped prior to the sheath contacting the person.

19. The method of claim 10, wherein the sheath comprises a metal sheet having a thickness of approximately ⅛ inch.

20. The method of claim 10, wherein the sheath comprises a deformable material selected from aluminum, steel, or polymeric material.

21. The method of claim 10, wherein the automated apparatus comprises a carwash system including a rotating cleaning element disposed opposite the counterweight.

22. The method of claim 10, wherein the arm rotates arcuately upwardly and downwardly about the axis while carrying the counterweight.
